(19) United States
(12) Patent Application Publication
(10) Pub. No.: US 2006/0119742 A1
(43) Pub. Date: Jun. 8, 2006

(54) Power managing electronic apparatus

(75) Inventor: Hee-jun Park, Seongnam-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/285,217

(22) Filed: Nov. 23, 2005

(30) Foreign Application Priority Data
Nov. 26, 2004 (KR) 10-2004-0098091

(51) Int. Cl. H04N 5/63

(52) U.S. Cl. 348/730

(57) ABSTRACT

An electronic apparatus including external power sources in different kinds, and a power supplying unit being supplied with power from the external power sources and supplying it as system power, including a source determination unit determining kinds of the external power sources; and a control unit controlling the power supplying unit based on the determination result by the source determination unit so that system power is supplied in a driving mode set in advance correspondingly to the concerned external power source. Thus, the electronic apparatus is capable of improving energy efficiency by changing its own driving state optimally according to the type of an external power source.

### CROSS-REFERENCE TO RELATED APPLICATIONS

This application claims the benefit of Korean Patent Application No. 10-2004-0098091, filed on Nov. 26, 2004, in the Korean Intellectual Property Office, the disclosure of which is incorporated herein by reference.

### BACKGROUND OF THE INVENTION

1. Field of the Invention

The present invention relates to an electronic apparatus, and more particularly, an electronic apparatus capable of improving energy efficiency by changing its own driving state optimally according to the type of an external power source.

2. Description of the Related Art

Referring to FIG. 1, a conventional electronic apparatus will be described briefly.

Generally an electronic apparatus includes an external power source 10 and a main body 100. The main body 100 includes an internal battery 9, a connection terminal 30 to receive power supplied from the external power source 10, and a user input unit 20. The main body 100 is driven by use of the power from the internal battery 9 or otherwise from the external power source 10. The external power source 10 may be classified into an AC adaptor 1 and a limited power source 5. The AC adaptor generally converts commercial AC power supplied thereto into DC power and supplies the converted DC power to the main body 100 whereas the limited power source 5 has a limit to an amount of power which can be supplied to the main body 100.

When the AC adaptor 1 is connected to the connection terminal 30, the conventional electronic apparatus receives power supplied from the AC adaptor 1, drives a system of the electronic apparatus generally in a normal mode and charges its internal battery 9.

When the limited power source 5 is in connection with the connection terminal 30, the conventional electronic apparatus can receive power supplied from the limited power source 5, and drive the system in a normal mode and charge its internal battery 9 in the same manner as when the AC adaptor 1 is connected to the connection terminal 30.

When the electronic apparatus is supplied with power from the limited power source 5, the durability of the limited power source 5 is shortened because the system is driven in a normal mode. In addition, since the internal battery 9 is charged, energy efficiency of the limited power source 5 is lowered.

### SUMMARY OF THE INVENTION

Accordingly, it is an aspect of the present invention to provide an electronic apparatus capable of improving energy efficiency by changing its own driving state optimally according to the type of external power source.

Additional aspects and/or advantages of the present invention will be set forth in part in the description which follows and, in part, will be apparent from the description, or may be learned by practice of the present invention.

The foregoing and/or other aspects of the present invention are also achieved by providing an electronic apparatus including external power sources of different kinds, and a power supplying unit being supplied with power from the external power sources and supplying it as system power, including a source determination unit determining the kind of external power source; and a control unit controlling the power supplying unit based on the determination result by the source determination unit so that system power is supplied in a driving mode set in advance corresponding to the external power source.

According to an aspect of the present invention, the external power source includes an AC adaptor converting AC power into DC power and outputting it, and a limited power source limited to the amount of power to be supplied; and the control unit controls the power supplying unit so that a system of the electronic apparatus is driven in a normal mode when power is supplied from the AC adaptor whereas it is driven in a power saving mode when power is supplied from the limited power source.

According to an aspect of the present invention, the electronic apparatus further includes a mode selection input unit to change a driving mode of the system regardless of the kind of the external power source, where the control unit controls the power supplying unit so that the system is driven in a driving mode as selected through the mode selection unit.

According to an aspect of the present invention, the mode selection input unit includes an OSD generating unit generating an OSD signal to display an OSD driving mode set screen through which the driving mode is changed, and a user input unit to allow a user to input with keys; and the control unit controls the OSD generating unit so as to allow an OSD signal to display the OSD driving mode set screen to be generated, where the external power source is changed according to the determination result of the source determination unit.

According to an aspect of the present invention, the control unit controls the power supplying unit so that the system is driven either in the power saving mode or in the normal mode as selected on the OSD driving mode set screen by manipulation of the user input unit.

According to an aspect of the present invention, the electronic apparatus further includes an internal battery; and a charge circuit unit to charge the internal battery, where the OSD driving mode set screen further displays charge-on/off functions to select charge-on or charge-off of the internal battery.

According to an aspect of the present invention, the control unit controls the charge circuit unit so that an operation to charge the internal battery is on or off according to charge-on or charge-off function as selected on the OSD driving mode set screen by manipulation of the user input unit.

According to an aspect of the present invention, the power supplying unit supplies the system power from one of the internal battery and the external power source as supplied; and the OSD driving mode set screen further displays a power source selection item to select the power source with the priority order to be used as the driving power between powers of the internal battery and the external power source.

According to an aspect of the present invention, the control unit controls the power supplying unit so that the system power is supplied based on power of the power source selected with the priority order in the power selection items of the OSD driving mode set screen by manipulation of the user input unit.

According to an aspect of the present invention, the charge circuit unit outputs a signal for charge completion to the control unit when charge of the internal battery is completed; and the control unit controls the OSD generating unit to display an OSD charge completed screen to indicate that charge of the internal battery is completed, and the OSD driving mode set screen, when the signal for charge completion is inputted.

According to an aspect of the present invention, the external power source stores type information of a power source therein and outputs the type information when power is supplied; and the source determination unit determines a kind of the external power source based on the type information inputted from the external power source.

According to an aspect of the present invention, the limited power source further stores residual power quantity information available for supply therein and outputs the residual power quantity information when power is supplied; further includes a residual quantity determination unit determining whether the residual power quantity is below the predetermined quantity, based on the residual power quantity information inputted from the limited power source; and the control unit controls the OSD generating unit so as to display the OSD residual quantity short screen and the OSD driving mode set screen when a signal for short residual quantity is inputted from the residual quantity determination unit.

### BRIEF DESCRIPTION OF THE DRAWINGS

The above and/or other aspects and advantages of the present invention will become apparent and more readily appreciated from the following description of the embodiments, taken in conjunction with the accompanying drawings of which:

FIG. 1 is a diagram illustrating an external appearance of a conventional electronic apparatus;

FIG. 2 is a block diagram of an electronic apparatus according to the present invention;

FIG. 3 is a flow chart of the electronic apparatus according to a first embodiment of the present invention;

FIG. 4 is a flow chart of the electronic apparatus according to a second embodiment of the present invention;

FIG. 5 is a diagram illustrating an OSD driving mode setting screen displayed on the electronic apparatus according to the present invention; and

FIG. 6 is a diagram further illustrating an OSD charge completed screen or an OSD residual quantity short screen displayed on the electronic apparatus according to the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to like elements throughout.

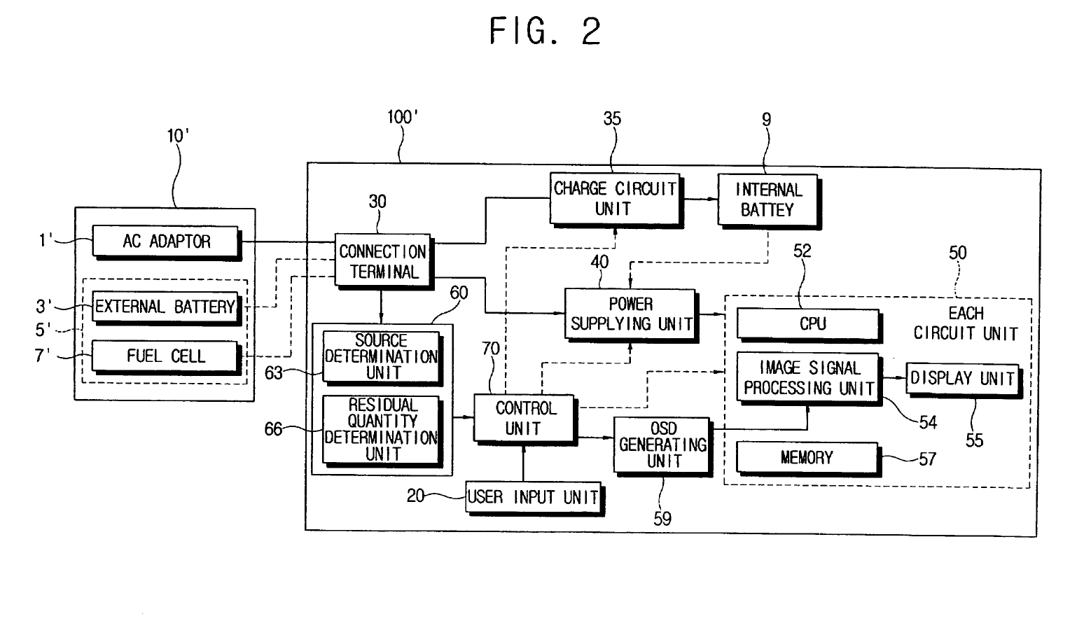

FIG. 2 is a control block diagram of an electronic apparatus according to the present invention. As illustrated, the electronic apparatus according to the present invention includes an external power source 10′, and a main body 100′ including an internal battery 9, where the electronic apparatus is driven by use of power supplied from the external power source 10′ or the internal battery 9. Herein, the electronic apparatus refers to a portable computer.

The external power source 10′ includes an AC adaptor 1′ converting AC power supplied from the outside into DC power and outputting it to a portable computer main body 100 through the connection terminal 30, and a limited power source 5′ having a limited amount of power and outputting it to the portable computer main body 100′ though the connection terminal 30.

Herein, the external power source 10′ includes a storage unit (not shown) storing therein type information of the power source, and outputs the type information when power is supplied to the portable computer main body 100′.

The limited power source 5′ may further store information the regarding residual quantity of power available for supply in the storage unit (not shown), and output the residual power quantity information along with the type information when power is supplied to the portable computer main body 100′. This kind of limited power source 5′ may include an external battery 3′ and a fuel cell 7′.

The portable computer main body 100′ includes an internal battery 9, a user input unit 20 to allow a user to input with keys, a connection terminal 30 receiving external power supplied from an external power source 10′ and type information and residual power quantity information of the external power source 10′, a power supplying unit 40 converting any one of external power supplied through the connection terminal 30 and internal power supplied from the internal battery 9 into driving power as requested respectively by various circuit units 50 within the computer and outputting it, a charge circuit unit 35 to charge the internal battery 9, an OSD generating unit 59 to generate an OSD signal to display an OSD screen, a determination unit 60 to determine a type or kind and a degree of residual quantity of the external power source 10′ based on the type information and residual power quantity information of the external power source 10′ inputted through the external terminal 30, and a control unit 70 controlling the OSD generating unit 59, the charge circuit unit 35 and a power supplying unit 40 to thereby change a driving state according to the type and residual power quantity of the external power source 10′ based on a result of determination by the determination unit 60.

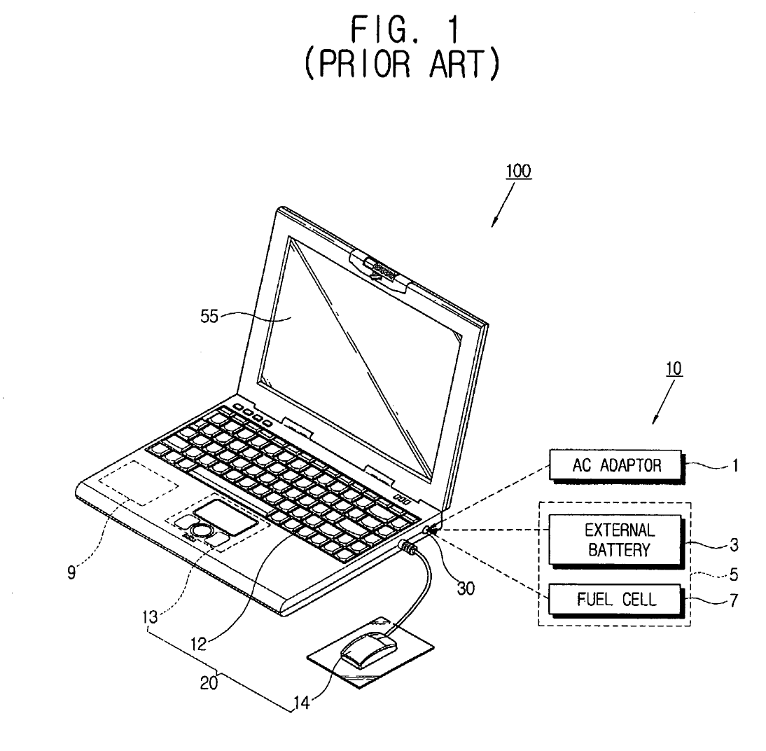

The user input unit 20 is provided with various means such as a keyboard 12, a touch pad 13 and a mouse 14 for input by a user, as illustrated in FIG. 1.

The power supplying unit 40 functions to convert power supplied into driving power corresponding to a normal mode or otherwise a power saving mode as requested by respective circuit units 50 based on control by the control unit 70 to be described later, and output it. In addition, the power supplying unit 40 selects any one of external power supplied through the connection terminal 30 and internal power supplied from the internal battery 9 based on control by the control unit 70 to be described later and converts it into driving power.

The charge circuit unit 35 functions to convert external power supplied through the connection terminal 30 into charge power and charge the internal battery 9 based on control by the control unit 70. In addition, the charge circuit unit 35 outputs a charge completion signal to the control unit 70 when charge of the internal battery 9 has been completed in the case of charging the internal battery 9.

Each circuit unit 50 includes a central processing unit (CPU) 52, an image signal processing unit 54, a display unit 55, a memory 57, an LCD driving unit (not shown) to drive an LCD (not shown) as the display unit 55, and a driving circuit to control driving of each function unit such as a USB controller (not shown) to control USB communication through a USB port (not shown).

The OSD generating unit 59 generates an OSD signal to display an OSD driving mode setting screen on the display unit 55, the OSD driving mode setting screen being designed to change a set driving mode of a system, select on/off setting of a charge operation to charge the internal battery 9 and a power source having a priority order to be used as driving power. In addition, the OSD generating unit 59 generates an OSD signal to display an OSD charge completed to inform that charge of the internal battery 9 is completed and an OSD residual quantity short screen to inform that residual power quantity of the limited power source 5′ is short. Herein, the OSD generating unit 59 may be configured with a mode selection input unit to select a driving mode of an electronic apparatus together with the user input unit 20.

The determination unit 60 includes a source determination unit 63 and a residual quantity determination unit 66. The source determination unit 63 receives type information of the external power source 10′ inputted through the connection terminal 30 and determines a kind of the external power source 10′ and the residual quantity determination unit 66 determines the residual power quantity of the external power source 10′ based on the residual power quantity information of the external power source 10′ inputted through the connection terminal 30.

When the external power source 10′ and the portable computer main body 100′ are connected to each other, the determination unit 60 may communicate with the external power source 10′ through a I2C bus or an SM bus to thereby be supplied with type information and residual quantity information of the external power source 10′.

Determination of a kind and residual power quantity of the external power source 10′ according to communication through the I2C bus or the SM bus is only by way of example. The determination unit 60 may not be provided with any separate communication line such as a I2C bus or SM bus, but is capable of determining a kind and residual power quantity of the external power source 10′ by use of a power line communication (PLC) or infer a kind of the external power source 10′ according to a voltage of the power supplied from the external power source 10′.

In this case, since there is in no need of a separate communication line such as I2C bus or SM bus, the external power source 10′ may include no storage unit (not shown) to store type information of the power source therein.

Where power is supplied by the AC adaptor 1′ connected to the connection terminal 30 based on the result of determination by the source determination unit 63, the control unit 70 controls the power supplying unit 40 so that the system of the electronic apparatus is driven generally in a normal mode. The normal mode generally refers to an operation that drives the CPU 52, and a driving circuit unit (not shown) that controls driving of the image signal processing unit 54 and each function unit, in a normal manner. The power supplying unit 40 supplies normal driving power to each circuit unit 50. In addition, the control part 70 controls the charge circuit unit 35 so as to charge the internal battery 9, where power is supplied from the AC adaptor 1′.

Where power is supplied by the limited power source 5′ connected to the connection terminal 30 based on the result of determination by the source determination unit 63, the control unit 70 controls the OSD generating unit 59 so that the OSD driving mode set screen to change the driving mode is displayed on the display unit 55.

When a power saving mode is selected on the OSD driving mode set screen by manipulation of the user input unit 20, the control unit 70 controls the power supplying unit 40 so that the system is driven in a power saving mode. The power saving mode generally refers to an operation to reduce an amount of power consumed to the extent that it does not affect a driving state of the system. Under the power saving mode, power saving may be realized through various methods, such that the driving circuit unit (not shown) is controlled to allow driving of any function unit unnecessary to be off, or frequency speed of the CPU 52 is lowered, by controlling driving power supplied from the power supplying unit 40 to each circuit unit 50.

In addition, the control unit 70 controls the charge circuit unit 35 so that an operation to charge the internal battery 9 is on or off as a charge function is turned on or off as selected on the OSD driving mode set screen by manipulation of the user input unit 20. Further the control unit 70 controls the power supplying unit 40 so that power of the power source selected with the priority order in the power selection items of the OSD driving mode set screen is converted into the driving power of the computer and then outputted. In other words, where the limited power source 5′ is connected to the connection terminal 30, when the internal battery 9 is selected owing to the priority order in the power selection items of the OSD driving mode set screen, the control unit 70 controls the power supplying unit 40 so that power of the internal battery 9 is converted into power to drive the computer and then outputted.

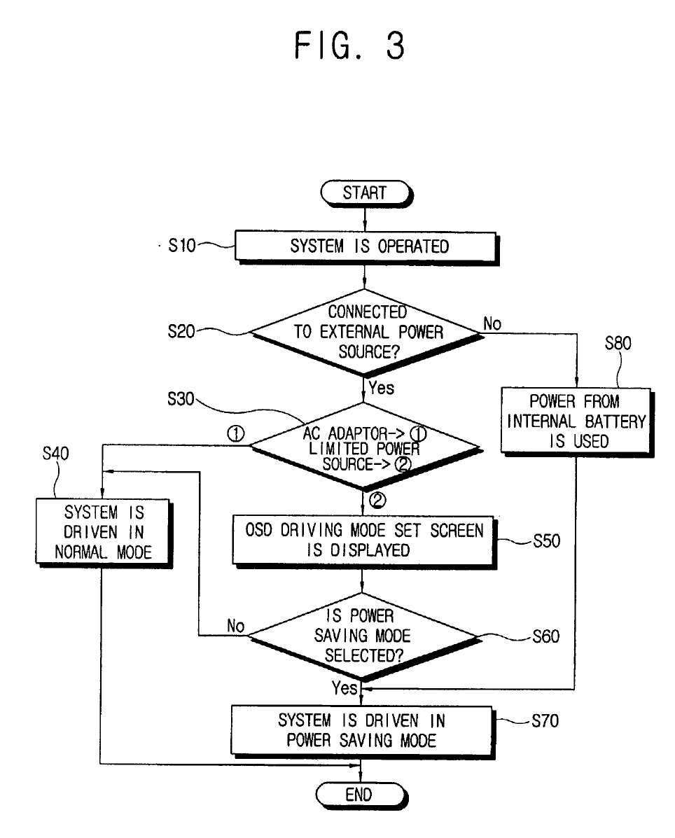

Control of the electronic apparatus with the configuration described above according to a first embodiment of the present invention will be described with reference to FIG. 3. A system of the portable computer main body 100′ is in operation at operation S10, the control unit 70 determines whether the portable computer main body 100′ is connected to the external power source 10′ at operation S20. When it is determined that the portable computer main body 100′ is connected to the external power source 10′, the control unit 70 determines whether the AC adaptor 1′ or the limited power source 5′ is connected thereto, based on the result of the determination by the source determination unit 63 at operation S30. When the AC adaptor 1′ is in connection, the control unit 70 controls the power supplying unit 40 to thereby drive the system in a normal mode at operation S40. When the limited power source 5′ is connected according to the determination result at operation S30, the control unit 70 controls the OSD generating unit 59 so as to display the OSD driving mode set screen on the display unit 55 at operation S50. The control unit 70 determines whether a power saving mode is selected on the OSD driving mode set screen by manipulation of the user input unit 20 at operation S60. When the power saving mode is selected according to the determination result, the control unit 70 controls the power supplying unit 40 to thereby drive the system in a power saving mode at operation S70. Herein, when the normal mode is selected according to the determination result at operation S60, the control unit 70 controls the power supplying unit 40 to thereby drive the system in a normal mode at operation S40. However, where it is determined at operation S20 that the external power source 10′ is not connected, the control unit 70 controls the power supplying unit 40 so as to use power of the internal battery 9 as a system driving power.

It is not illustrated in FIG. 3, but the control unit 70 generally controls the charge circuit unit 35 to thereby charge the internal battery 9 with power of the AC adaptor 1′ when power of the AC adaptor 1′ is supplied to the portable computer main body 100′. Further, generally when the external power source 10′ is not connected, the control unit 70 controls the power supplying unit 40 to drive the system in a power saving mode.

However, automatic driving of the system in a power saving mode where the external power source 10′ is not connected as described above is merely by way of example. Herein, where the external power source 10′ is not connected to the portable computer main body 100′ for which the system is driven with power of the internal battery 9, it is also possible to display the OSD driving mode set screen and select a normal mode or a power saving mode by manipulation of the user input unit 20.

The above-described configuration that the system is automatically driven in a normal mode and charges the internal battery 9 where power is supplied from the AC adaptor 1′ is merely by way of example. Herein, it is also possible for the portable computer to display the OSD driving mode set screen, and select a power saving mode or a normal mode by manipulation of the user input unit 20 and on/off of the charge function of the internal battery 9 while it is driven with power of the AC adaptor 1′.

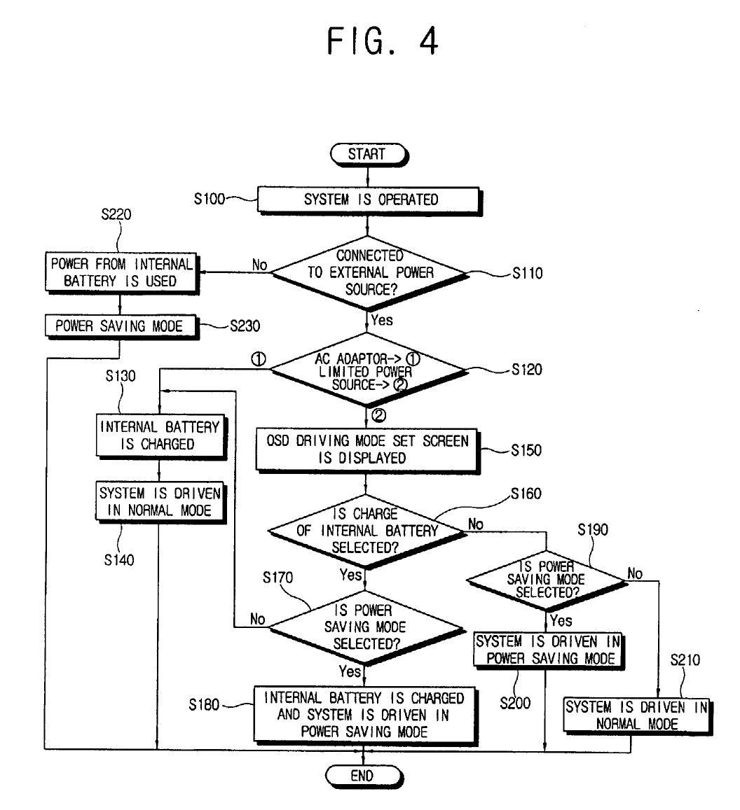

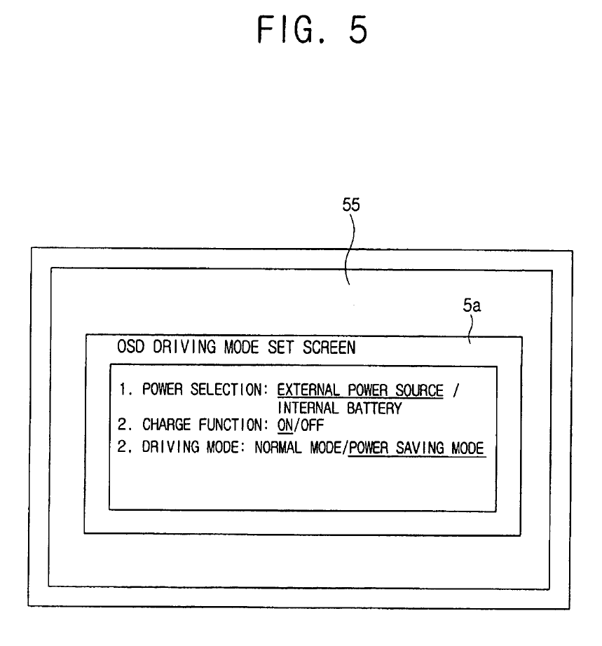

Control flow of the electronic apparatus according to a second exemplary embodiment of the present invention will be described with reference to FIGS. 4 to 6. While the system of the portable computer main body 100′ is in operation, the control unit 70 determines whether the external power source 10′ is connected to the portable computer main body 100′ at operation S110. Where it is determined that the portable computer main body 100′ is connected to the external power source 10′, the control unit 70 determines whether the AC adaptor 1′ or the limited power source 5′ is connected thereto, based on the result of determination by the source determination unit 63 at operation S120. When the AC adaptor 1′ is in connection, the control unit 70 controls the charge circuit unit 35 to charge the internal battery 90 at operation S130, and controls the power supplying unit 40 to thereby drive the system in a normal mode at operation S140.

Where the limited power source 5′ is connected according to the determination result at operation S120, the control unit 70 controls the OSD generating unit 59 so as to display the OSD driving mode set screen 5a on the display unit 55 as illustrated in FIG. 5 at operation S150. The control unit 70 determines whether a charge-on function of the internal battery 9 in item 2 of the OSD driving mode set screen 5a is selected by manipulation of the user input unit 20 at operation S160. Where the charge-on function of the internal battery 9 is selected, the control unit 70 determines whether a power saving mode in item 3 of the OSD driving mode set screen 5a is selected by manipulation of the user input unit 20 at operation S170. When the power saving mode is selected, the control unit 70 controls the charge circuit unit 35 and the power supplying unit 40 to thereby charge the internal battery 9 and drives the system in a power saving mode at operation S180.

Where a normal mode is selected according to the determination result at operation S170, the control unit 70 controls the charge circuit unit 35 and the power supplying unit 40 to thereby charge the internal battery 9, and drives the system in a normal mode at operations S130 and S140. Where a charge-off function of the internal battery 9 is selected at operation S160, the control unit 70 determines whether a power saving mode in item 3 of the OSD driving mode set screen 5a is selected by manipulation of the user input unit 20 at operation S190. When a power saving mode is selected according to the determination result, the control unit 70 controls the charge circuit unit 35 and the power supplying unit 40 so as not to charge the internal battery 9, and drives the system in a power saving mode S200. However, where a normal mode is selected according to the determination result at operation S190, the control unit 70 controls the charge circuit unit 35 and the power supplying unit 40 so as not to charge the internal battery 9, and drives the system in a normal mode at operation S210.

Where it is determined at operation S100 that the external power source 10′ is not connected, the control unit 70 controls the power supplying unit 40 and uses the power of the internal battery 9 as a system driving power at operation S220, and controls the power supplying unit 40 to drive the system in a power saving mode at operation S230.

It is not illustrated in the control flow chart of FIG. 4, but the control unit 70 uses a power source selected with the priority order in item 1 (power selection) of the OSD driving mode set screen 5a through manipulation by the user input unit 20 as the system driving power. FIG. 5 illustrates an example that an external power source, namely, the limited power source 5′ is selected as a power source, a charge-on function of the internal battery 9 is selected and the system is driven in a power saving mode having the priority order.

TABLE 1

| Connection | Type of | | Charge-on | |
|---|---|---|---|---|
| state to | external | | or off of | |
| external | power | Priority of | internal | |
| power source | source | power source | battery | Driving mode |
| Not | X | Internal | OFF | Power saving |
| connected | | battery | | mode |
| Connected | AC adaptor | Select AC | ON | Normal mode |
| | | adaptor or | | |
| | | internal | | |
| | | battery | | |
| | Limited | Select limited | Select on | Select normal |
| | power | power source | or off | mode or power |
| | source | or internal | | saving mode |
| | | battery | | |

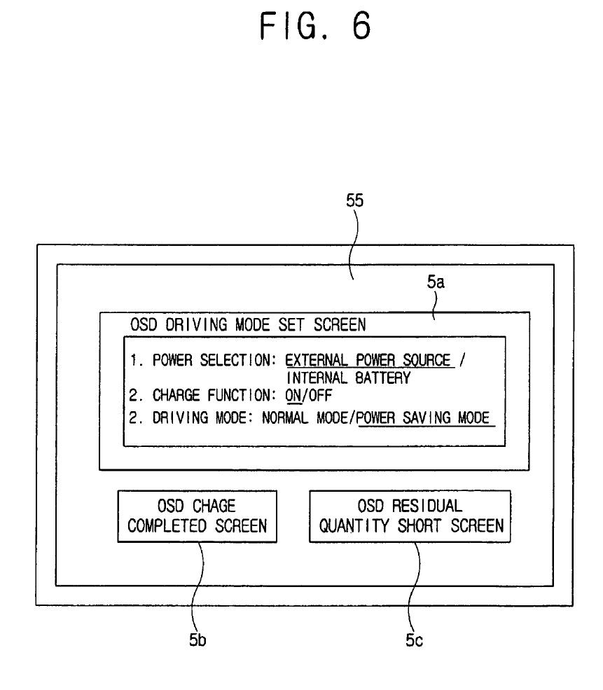

When a signal for charge completion from the charge circuit unit 35 is inputted into the control unit 70, the control unit 70 controls the OSD generating unit 59 so as to re-display an OSD driving mode set screen 5a on a display unit 55 along with an OSD charge-completed screen 5b to indicate that charge of the internal battery 9 is completed as illustrated in FIG. 6. Accordingly, the user recognizes that charge of the internal battery 9 is completed and can re-change a driving state of the system through the OSD driving mode set screen 5a.

Where a signal for short residual quantity to indicate that the residual power quantity of the limited power source 5′ is short of the predetermined quantity is inputted from a residual quantity determination unit 66, the control unit 70 controls the OSD generating unit 59 so as to re-display an OSD residual quantity short screen 5c and the OSD driving mode set screen 5a. Accordingly, the user can recognize that residual power quantity of the limited power source 5′ is short and can change the driving state of the system through the OSD driving mode set screen 5a.

According to this, when any change associated with power source, such as completed charge of the internal battery 9 or short residual power quantity of the limited power source 5′ has occurred, such a change is known to the user whereby it is possible for the user to reset a driving state of the system through the OSD driving mode set screen 5a.

As described above, an electronic apparatus with the configuration according to the present invention is capable of extending durability of the limited power source 5′ and increasing energy efficiency since a user is allowed to select charge-on or off of the internal battery 9, a system driving mode and power source used with the priority order, where a kind of the external power source 10, for example, the limited power source 5′, is determined.

According to the present invention, there is provided an electronic apparatus capable of improving energy efficiency by changing its driving state optimally according to the kind of external power source.

According to this, a driving state of the portable computer with the above-described configuration may be automatically changed as in Table 1 according to a state of the power source or may be established by a user through an OSD driving mode set screen.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An electronic apparatus including external power sources in different kinds, and a power supplying unit being supplied with power from the external power sources and supplying it as system power, comprising:
a source determination unit determining kinds of the external power sources; and
a control unit controlling the power supplying unit based on the determination result by the source determination unit so that system power is supplied in a driving mode set in advance corresponding to the concerned external power source.

2. The electronic apparatus of claim 1, wherein the external power source comprises an AC adaptor converting AC power into DC power and outputting it, and a limited power source limited to the amount of power to be supplied; and
the control unit controls the power supplying unit so that a system of the electronic apparatus is driven in a normal mode when power is supplied from the AC adaptor whereas it is driven in a power saving mode when power is supplied from the limited power source.

3. The electronic apparatus of claim 2, further comprising a mode selection input unit to change a driving mode of the system regardless of the kind of the external power source,
wherein the control unit controls the power supplying unit so that the system is driven in a driving mode as selected through the mode selection unit.

4. The electronic apparatus of claim 3, wherein the mode selection input unit comprises an OSD generating unit generating an OSD signal to display an OSD driving mode set screen through which the driving mode is changed, and a user input unit to allow a user to input with keys; and
the control unit controls the OSD generating unit so as to allow an OSD signal to display the OSD driving mode set screen to be generated, where the external power source is changed according to the determination result of the source determination unit.

5. The electronic apparatus of claim 4, wherein the control unit controls the power supplying unit so that the system is driven either in the power saving mode or in the normal mode as selected on the OSD driving mode set screen by manipulation of the user input unit.

6. The electronic apparatus of claim 5, further comprising:
an internal battery; and
a charge circuit unit to charge the internal battery,
wherein the OSD driving mode set screen further displays charge-on/off functions to select charge-on or charge-off of the internal battery.

7. The electronic apparatus of claim 6, wherein the control unit controls the charge circuit unit so that an operation to charge the internal battery is on or off according to charge-on or charge-off function as selected on the OSD driving mode set screen by manipulation of the user input unit.

8. The electronic apparatus of claim 7, wherein the power supplying unit supplies the system power from one of the internal battery and the external power source as supplied; and
the OSD driving mode set screen further displays a power source selection item to select the power source with the priority order to be used as the driving power between powers of the internal battery and the external power source.

9. The electronic apparatus of claim 8, wherein the control unit controls the power supplying unit so that the system power is supplied based on power of the power source selected with the priority order in the power selection items of the OSD driving mode set screen by manipulation of the user input unit.

10. The electronic apparatus of claim 9, wherein the charge circuit unit outputs a signal for charge completion to the control unit when charge of the internal battery is completed; and
the control unit controls the OSD generating unit to display an OSD charge completed screen to indicate that charge of the internal battery is completed, and the OSD driving mode set screen, when the signal for charge completion is inputted.

11. The electronic apparatus of claim 10, wherein the external power source stores type information of a power source therein and outputs the type information when power is supplied; and
the source determination unit determines a kind of the external power source based on the type information inputted from the external power source.

12. The electronic apparatus of claim 11, wherein the limited power source further stores residual power quantity information available for supply therein and outputs the residual power quantity information when power is supplied;
further comprises a residual quantity determination unit determining whether the residual power quantity is below the predetermined quantity, based on the residual power quantity information inputted from the limited power source; and
the control unit controls the OSD generating unit so as to display the OSD residual quantity short screen and the OSD driving mode set screen when a signal for short residual quantity is inputted from the residual quantity determination unit.

13. The electronic apparatus of claim 5, wherein the external power source stores type information of a power source therein and outputs the type information when power is supplied; and
the source determination unit determines a kind of the external power source based on the type information inputted from the external power source.

14. The electronic apparatus of claim 13, wherein the limited power source further stores residual power quantity information available for supply therein and outputs the residual power quantity information when power is supplied;
further comprises a residual quantity determination unit determining whether the residual power quantity is below the predetermined quantity, based on the residual power quantity information inputted from the limited power source; and
the control unit controls the OSD generating unit so as to display the OSD residual quantity short screen and the OSD driving mode set screen when a signal for short residual quantity is inputted from the residual quantity determination unit.
